(19) United States
(12) Patent Application Publication
(10) Pub. No.: US 2014/0263026 A1
(43) Pub. Date: Sep. 18, 2014

(54) Filtration Media and Filter Therefor

(71) Applicant: Hayward Industries, Inc., Elizabeth, NJ (US)

(72) Inventor: Kevin Potucek, Far Hills, NJ (US)

(73) Assignee: HAYWARD INDUSTRIES, INC., Elizabeth, NJ (US)

(21) Appl. No.: 14/210,835

(22) Filed: Mar. 14, 2014

Related U.S. Application Data
(60) Provisional application No. 61/794,987, filed on Mar. 15, 2013.

(51) Int. Cl. B01D 71/36; B01D 63/06; B01D 71/34; B01D 65/02

(52) U.S. Cl. CPC B01D 71/36; B01D 65/02; B01D 63/06; B01D 71/34
USPC 210/323.1; 210/500.21; 210/483; 210/497.01; 210/500.42

(57) ABSTRACT

A filtration media and a filter assembly therefor is provided. The filtration media comprising a membrane having an ingress side and an egress side which permit the passage of water, the ingress side including a coating of a material having a low friction coefficient, said coating preventing passage of particulate and holding the particulate on the ingress side when flow from a filter pump is present, and wherein the particulate falls off of the coating when flow from the filter is reduced.

### CROSS-REFERENCE TO RELATED APPLICATION

This application claims priority to U.S. Provisional Patent Application No. 61/794,987 filed on Mar. 15, 2013, which is incorporated herein by reference in its entirety.

### BACKGROUND OF THE INVENTION

1. Field of the Disclosure

The present disclosure relates to a filtration media and filter therefor.

2. Background

Pool filter performance is generally defined by three elements: quality of filtration, ease of cleaning, and time between cleaning (filter cycle).

With respect to the quality of filtration, the finer the particulate the filter will capture from the pool water being filtered is considered to be a higher quality of filtration. Generally, Diatomaceous Earth (DE) filters provide the highest quality of water filtration, capturing particulate as small as 5 microns. Cartridge filters are considered the second highest quality of filtration, capturing particles as small as 10-15 microns. Sand filters are the poorest quality of filtration, capturing particles in the 20-30 micron range. All filters, particularly sand and cartridge clean better as they get dirty, but the pressure loss in the system goes up measurably as they get dirty.

With respect to the ease of cleaning, there are pros and cons to each method of filtration as it relates to cleaning the media. Sand is often considered the easiest because you simply reverse the flow of water through the filter, “backwashing” the filtered particulate to waste. The backwash is achieved by simply changing the position of a valve and then returning it to the original position after the backwash. The next easiest filtration method is likely DE. It is still backwashable but requires a recharge of the DE after backwash. The least easiest to clean is cartridge filters. They are a messy, manual cleaning. This manual cleaning does, however, require the least amount of water for cleaning.

Finally, with respect to the time between cleaning (filter cycle), the longer between required cleaning the better. Depending on size, DE or cartridge filters offer the longest time between cleaning, typically 3-6 months. Sand filters require back-washing every week or two.

### SUMMARY

The present disclosure relates to a filtration media and a filter assembly therefor. The filtration media comprising a membrane having an ingress side and an egress side which permit the passage of water, the ingress side including a coating of a material having a low friction coefficient, said coating preventing passage of particulate and holding the particulate on the ingress side when flow from a filter pump is present, and wherein the particulate falls off of the coating when flow from the filter is reduced.

### BRIEF DESCRIPTION OF THE DRAWINGS

The foregoing features of the disclosure will be apparent from the following Detailed Description, taken in connection with the accompanying drawings, in which:

FIGS. 1 and 2 are top and side views, respectively, of the filtration media of the present disclosure and a sample filter in which the filtration media of the present invention could be used.

FIG. 3 is a cross-sectional view of the filtration media taken along section A-A of FIG. 1.

### DETAILED DESCRIPTION

The present invention relates to a novel filtration media and a filter assembly therefor.

FIGS. 1 and 2 are top and side views, respectively, of the filtration media of the present disclosure and a sample filter in which the filtration media of the present invention could be used. The filtration assembly 10 comprises a tank 12 comprising, an upper portion 16, a bottom portion 22, a water inlet 14 (e.g., unfiltered water entrance) in the upper portion 16, a water outlet 18 (e.g., filtered water exit), and a holding chamber 20 at the bottom portion 22 of the tank 12, a grate 24 positioned within the tank 12 and separating the holding chamber 20 from the upper portion 16 of the tank 12, and a filtration media 30 positioned within the upper portion 16 of the tank 12, the filtration media 30 comprising a filter membrane having a lubricious surface 31 for automatic de-caking of particulate when a pump connected to the tank 12 is turned off, wherein when the pump is turned off the particulate de-cakes from the filtration media and drops through the grate 24 to the holding chamber 20. The tank 12 including a tank lid 32 and a filter base/stand 34 (FIG. 1 being a top view with the tank lid 32 removed). The filtration assembly further comprising a drain port 36 (e.g., drain/cleanout port) at a bottom of the tank for removal of the particulate in the holding chamber 20, with a removeable 38 clean-out cap at an end thereof. The pressure differential could be terminated by turning off a pump providing water flow 40 into-the upper portion 16 of the tank 12 through the water inlet 14.

The principle of the filtration media 30 of the present invention (also referred to herein as “4^{th} Media Filter”) is as follows:

The filtration media 30 has filtration quality of DE. It is easier to clean than sand. It has extended filter cycles (time between cleaning) surpassing DE and large cartridge. It includes a two-dimensional filtration media similar to non-woven polyester in current cartridge filters.

The media 30 includes a two-dimensional fabric/membrane like non-woven polyester. A lubricious surface 31 is included to promote automatic de-caking of particulate when pump is turned off (off cycle) and pressure differential is terminated.

The fabric/membrane is designed to deliver to 5 micron filtration when clean.

The filter area is designed to hold particulate for one turnover filtration cycle without greater than 5 psi increase in pressure drop.

Because the filter media 30 is designed to hold only one day's (one turnover's) particulate, square footage of media should be able to be dramatically reduced, eliminating the need for deep pleats or even eliminating pleats altogether. The media 30 may simply be wrapped around a cylinder with supporting “mesh” as required. Reduced area and pleat elimination reduces cost as well as promotes auto-decaking.

The filtration assembly 10 of the present invention is discussed as follows. The filter tank 12 should have a “stagnant holding chamber” 20 at the bottom 22 of the tank 12 providing ample “storage” for months of filtered particulate that has decaked from the media 30 during the “off cycle”. This chamber 20 is segregated from the upper portion 16 of the tank 12 (portion with 4th media cylinder) by a grate 24 that allows particulate to drop through during the “off cycle” but also provides a baffle that inhibits the agitation of stored particulate during the active filtration cycle. This grate 24 may be little more than a 1″ thick grid with 1″ square openings.

The tank bottom has a drain port 36 that allows the easy pressurized or unpressurized removal of the stagnant particulate every 3, 6 or even 12 months. Required “flush” would consume less water than would the cleaning of a conventional cartridge.

Preliminarily, the “4th media” is a Donaldson Teflon membrane, but other fabrics/membranes may yield superior cost/performance/reliability.

Further features of the media include:
Porex cartridges and/or perflex fingers
“Goretex-like” teflon coating of non-woven polyester will deliver cost effective, DE quality filtration while providing water conservation and infrequent service common to large cartridge filtration. Low friction coating and fewer pleats will allow particulate to de-cake during off cycle and collect in “dirt collection well” in bottom of filter. New media coating may also be suited for Perflex and vertical grid, while eliminating DE.

The filter (e.g., filter assembly) 10 could be a single cycle filter (e.g., water filter used with a pool or spa) with multiple cycle particulate storage, and could comprise a pressure vessel (e.g., tank) 12 with one or more primary internal sections. The internal sections could include a dynamic flow section (e.g., upper section) 16 for in-cycle capture of particulate and a static section (e.g., bottom section) 22 for long-term (e.g., multiple cycle) storage of particulate. These internal sections could be separated by a grid/baffle 24 to inhibit turbulence in the static section 22.

The grid/baffle 24 could have a “knife” upper/leading edge to inhibit de-caked particulate from coming to rest on the grid 24 rather than passing through. For example, a first edge (e.g., particulate ingress edge) could be of a smaller dimension than its second edge (e.g., particulate egress edge). The grid 24 promotes one way passage of particulate through the grid 24 when the filter is in off-cycle, and could also inhibit turbulence below the grid 24 when the filter 10 is in on-cycle (e.g., by baffles).

The filter 10 could further comprise a drain port 36 that permits the draining of water (with or without large particulate). The drain port 36 could accommodate the connection of a hose and/or a particulate collection device (e.g., after a cap or plug assembly 38 is removed and/or the water drained) for the removal of particulate from the filter 10 (e.g., pumping water into the tank/vessel 12 by a filter pump).

The filter 10 could further comprise a mechanical, hydraulically driven mechanical or electromechanical device to, at the end of a cycle, momentarily reverse flow through the filtration media 30 (and/or imposes vibration to the filtration media 30) to promote de-caking of particulate (e.g., from ingress side of the filtration media 30).

FIG. 3 is a cross-sectional view of the filtration media taken along section A-A of FIG. 1. One or more filtration media 30 (e.g., filter media, filter media element) of any suitable shape (e.g., cylindrical, cubical, any other shape, etc.) could be used with any suitable filter (e.g., filter assembly), with each filtration media 30 having a water ingress side 50 and a water egress side 52. The ingress side 50 and egress side 52 could include one or more membranes/substrates 56 contacting and/or positioned proximate to one another.

The filtration media 30 could include one or more substrates/membranes 56 of one or more materials (and/or one or more membranes 56 having one or more coatings 54) such that the ingress side 50 prevents passage of particulate larger than a specified size, holds particulate on the ingress side 50 when flow is present, and drops off (e.g., de-cakes) the particulate when flow is reduced or suspended. The membrane 56 and/or coating 54 could be of a material having a low coefficient of friction (e.g., polytetrafluorethylene (Teflon)). Membrane 56 and coating 54 could be replaced by a single membrane (without a coating) having a low coefficient of friction to promote de-caking when flow is reduced or not present (e.g., when the pool pump is turned off).

Openings in the ingress side 50 could be smaller than openings in the egress side 52, thereby inhibiting particulate from being trapped within the filtration media 30. The water ingress side 50 could include a coating 54, and/or an enhanced surface, with a low coefficient of friction which (i) promotes de-caking when flow is reduced or not present (e.g., when the pool pump is turned off), (ii) permits the passage of water, and/or (iii) inhibits particulate from imbedding in the filtration media. The ingress side 50 could be flat, non-pleated, and/or of simple radius about no less than 4 inches such that debris is not easily trapped in pleats or tight radii.

The membrane 56 of the filtration media 30 could be supported by a support structure 58 (e.g., rigid/semi-rigid substrate, rods, etc.), such as to hold the one or more membranes 56 in a desired position. The ends of the membranes 56 (and/or substrate 58) could be secured to endcaps 60 and/or itself (e.g., overlapping seam) by thermal bonding and/or chemical bonding. For example, the membrane 56 could be potted in the endcaps 60 with a thermosetting polymer.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected is set forth in the following claims.

What is claimed is:

1. A filtration media comprising:
a membrane having an ingress side and an egress side which permit the passage of water, the ingress side including a coating of a material having a low friction coefficient, said coating preventing passage of particulate and holding the particulate on the ingress side when flow from a filter pump is present, and wherein the particulate falls off of the coating when flow from the filter is reduced.

2. The filtration media of claim 1, further comprising a support structure connected to and supporting the membrane.

3. The filtration media of claim 1, further comprising one or more additional membranes.

4. The filtration media of claim 1, wherein openings in the ingress side of the membrane are smaller than openings in the egress side to prevent particulate from imbedding therein.

5. The filtration media of claim 1, wherein the ingress side is non-pleated.

6. The filtration media of claim 1, wherein the membrane is cylindrical in shape.

7. The filtration media of claim 1, wherein the membrane comprises polytetrafluorethylene.

8. The filtration media of claim 1, wherein the coating comprises polytetrafluorethylene.

9. The filtration media of claim 1, further comprising endcaps secured to ends of the membrane.

10. The filtration media of claim 1, wherein the endcaps are secured to the membrane by thermal bonding.

11. The filtration media of claim 1, wherein the endcaps are secured to the membrane by chemical bonding.

12. A filtration media comprising:
a membrane having an ingress side and an egress side which permit the passage of water, the membrane having a low friction coefficient, said membrane preventing passage of particulate and holding the particulate on the ingress side when flow from a filter pump is present, and wherein the particulate falls off of the membrane when flow from the filter is reduced.

13. The filtration media of claim 12, further comprising a support structure connected to and supporting the membrane.

14. The filtration media of claim 12, further comprising one or more additional membranes.

15. The filtration media of claim 12, wherein openings in the ingress side of the membrane are smaller than openings in the egress side to prevent particulate from imbedding therein.

16. The filtration media of claim 12, wherein the ingress side is non-pleated.

17. The filtration media of claim 12, wherein the membrane is cylindrical in shape.

18. The filtration media of claim 12, wherein the membrane comprises polytetrafluorethylene.

19. The filtration media of claim 12, further comprising endcaps secured to ends of the membrane.

20. The filtration media of claim 12, wherein the endcaps are secured to the membrane by thermal bonding or chemical bonding.
